(19) United States
(12) Patent Application Publication
(10) Pub. No.: US 2025/0108462 A1
(43) Pub. Date: Apr. 3, 2025

(54) Method for detecting a lens and/or nozzle on a focusing unit of a laser plotter for cutting, engraving, marking and/or labeling a workpiece, as well as a lens holder, a nozzle holder and a laser plotter for engraving, marking and/or labeling a workpiece therefor

(71) Applicant: Trotec Laser GmbH, Marchtrenk (AT)

(72) Inventor: Paul HAGER, Bad Wimsbach (AT)

(21) Appl. No.: 18/729,947

(22) PCT Filed: Dec. 16, 2022
(86) PCT No.: PCT/AT2022/060446

§ 371 Date: Jul. 18, 2024

(30) Foreign Application Priority Data
Jan. 19, 2022 (AT) A50020/2022
Sep. 20, 2022 (AT) A50723/2022

(51) Int. Cl. B23K 26/70; B23K 26/08; B23K 26/14

(52) U.S. Cl. CPC B23K 26/707; B23K 26/0876; B23K 26/1482

(57) ABSTRACT

The invention relates to a laser plotter, a lens holder, a nozzle holder and a method for detecting a lens and/or nozzle on a focusing unit of a laser plotter for cutting, engraving, marking and/or labeling a workpiece. At least one irradiation source in the form of a laser is used in a housing of the laser plotter. When the irradiation source is activated, a laser beam is directed via deflection elements to a focusing unit, and a processing table or processing chamber is captured via at least one camera. For detection of the lens and/or nozzle, the focusing unit is moved to a defined position at which the lens and/or nozzle is clearly visible to the camera, whereupon an image of the focusing unit is recorded via the camera and the lens and/or nozzle is detected in the image via an analysis tool.

### TECHNICAL FIELD

The present disclosure relates to a method for detecting a lens and/or nozzle on a focusing unit of a laser plotter for cutting, engraving, marking and/or labeling a workpiece, as well as to a lens holder, a nozzle holder and a laser plotter for engraving, marking and/or labeling a workpiece.

### DESCRIPTION OF THE RELATED ART

Laser machines or laser plotters in which one or more laser sources are operated are already known from the prior art. To this end, a laser beam is sent from the laser source to a laser head or a focusing unit, whereby the laser beam is focused in the laser head or the focusing unit via an optical element, in particular a lens. Furthermore, the laser head or the focusing element or the focusing unit comprise a nozzle, whereby selection of the correct nozzle influences the quality of the processing, in particular the engraving, and the nozzle also protects the lens from dust or smoke.

DE 10 2011 078 359 A1 discloses a system for a laser head in which a transponder containing readable information is arranged on an optical element, in particular a lens. The information is read by a read and/or write unit assigned to the transponder. The optical element and the associated read and/or write unit are arranged inside the housing of the laser head. The disadvantage here is that the lens is located inside the laser head, which means that it cannot be replaced quickly and easily.

JP2004322127A discloses a laser beam machine and a method for lens and nozzle handling in which bar codes are attached to the laser head for the lens and nozzle as a means of discrimination. To scan the means of discrimination, a barcode reader is provided in the processing chamber of the laser beam machine near the processing table so that the laser head is positioned at the barcode reader while the barcodes are scanned. The disadvantage here is that a special position outside the processing table must be moved to in to query/detect the lens and nozzle.

Furthermore, WO2016093053A1 discloses a laser processing machine with a nozzle mounting method where an image recording element is arranged inside the laser head for recording an image via which a code of nozzles deposited at a nozzle deposit location is recorded and detected so that a corresponding nozzle can be selected and attached to the laser head. The disadvantage here is that the laser head must have an additional component, namely the image acquisition element, which makes the design of the laser head very complicated and costly.

WO2020127492A1 discloses a metalworking device with a gas nozzle, in which an electronic camera is provided for capturing a digital image of the gas nozzle. To this end, the camera is arranged in a nozzle centering station, whereby the laser head is stationed above the camera so that an image of the gas nozzle with the nozzle outlet opening is taken from below in order to determine the degree of wear of the gas nozzle.

Furthermore, systems by the applicant, in particular by Trotec Laser GmbH, are known in which the optical element, in particular the lens, is integrated into a lens housing, whereby the lens housing can be inserted from the outside into a receiving element or a lens mount. This makes it easy to replace or clean the lens by turning a fastening wheel to release the clamped lens housing and remove the lens housing together with the lens. The disadvantage here is that although it is easy to replace the lens, the lens type must be selected manually in the software upon replacement of the lens. This can result in incorrect values being entered or selected in the software, or the user forgetting to adjust the lens parameters in the software.

### SUMMARY OF EMBODIMENTS

The task of the disclosed embodiments is to create a method for detecting a lens and/or nozzle on a focusing unit of a laser plotter, a lens holder, a nozzle holder and a laser plotter for this purpose, in which, on the one hand, the above-mentioned disadvantages are avoided and, on the other hand, a high degree of user-friendliness is achieved.

The objective is achieved by the present disclosure. Advantageous embodiments and/or process measures are described in the dependent claims.

The objective of the present disclosure is achieved by a method for detecting a lens and/or nozzle on a focusing unit of a laser plotter for cutting, engraving, marking and/or lettering a workpiece, in which in order to determine the lens and/or nozzle the focusing unit is adjusted to a defined position in which the lens and/or nozzle is clearly visible to the camera, whereupon an image of the focusing unit is recorded via the camera and the lens and/or nozzle is detected in the image via an analysis tool.

The advantage here is that adjusting or moving the focusing unit to a position in which the lens, in particular the lens housing, and/or the nozzle is very clearly visible makes it possible to generate an image of sufficiently high quality so that the lens and/or nozzle can be reliably evaluated. If the focusing unit were to remain in the resting position for recording the image upon activation for lens and/or nozzle detection, there would be a very large distance between the focusing unit and the camera, which is preferably arranged on the lid of the laser plotter, so that the evaluation of the recorded image would not reveal any details, such as imprints, letterings, engravings or colors. It is therefore advantageous to have the focusing unit moved or positioned as close as possible to the camera so that a clearly visible image, particularly at close range to the camera, is captured by the focusing unit or a part of the focusing unit. Here it is also possible to adjust the table height accordingly in order to capture a high-quality image. Thus it is also possible to move to several different positions to determine the lens and/or nozzle, whereby the analysis tool takes an image each time for evaluation. Furthermore, it is also possible to move, depending on the lens and/or nozzle selected in the software, to various positions for capturing an image, in order to be able to generate the best possible image for checking the lens and/or nozzle used. It is also possible that in case of a plurality of cameras in the lid, only one camera is activated to record an image for detecting the lens and/or nozzle. It is also possible that a separate camera is used to detect the lens and/or nozzle, whereby this camera can also be positioned in the lid or on the side walls of the processing chamber. Furthermore it is possible that the image of the lens and/or nozzle is not captured directly, but via one or several mirrors in the processing chamber.

Advantageous embodiments are such in which the lens is identified by means of optical features, such as the color of the lens housing or an imprint on the lens housing or a lettering or engraving on the lens housing or the geometric shape or surface structure of the lens housing. This makes it possible to perform detection of the lens in various ways. On the one hand, it is possible that the color used for the lens housing can be evaluated and then a stored numerical value be assigned to the color that corresponds to the lens in a database. On the other hand, it is possible that the numerical value or an encoding or a code, such as a QR code, Data Matrix, in particular a Data Matrix code ECC200, barcode, graphic or a self-generated code, is printed, glued, labeled or engraved on the lens housing and the numerical value evaluated directly by the analysis tool. The shape or design of the lens housing can also be detected and compared with a database. Combination of optical and geometric features is also possible.

However, advantageous embodiments are also such in which the nozzle is identified by means of optical features, such as the color of the nozzle housing or an imprint on the nozzle housing or a lettering or engraving on the nozzle housing or the geometric shape or surface structure of the nozzle housing. This allows the nozzle, too, to be detected in various ways. As described above for the detection of the lens, these variants are possible for detection of the nozzle as well. This means that a wide variety of nozzles can be selected and/or checked for the selected machining process. For example, a short nozzle with a large hole diameter (7 mm) is used for the laser beam for engraving and cutting, whereby this nozzle is preferred when cutting acrylic, as the material does not cool down so quickly, resulting in a nice edge. A short nozzle with a small hole diameter (3 mm) is used mainly for cutting fuming materials, such as wood, as the small hole opening concentrates the air flow, which blows away the relevant fumes and cutting gases. However, this nozzle is not suitable for engraving dust-intensive materials, e.g. plastic, rubber, as the small opening of the nozzle will quickly become blocked. Use of a long nozzle with a small hole diameter (3 mm), for example, is advantageous also if a focus distance to the material needs to be compensated when using a 2.5″ lens. Of course, even further nozzle designs can also be used.

Advantageous embodiments are such in which criteria or default values for the lenses and/or nozzles are stored in a database. This ensures that special data, such as the focal length, can be retrieved for use of a specific lens in order to carry out a correct machining process. In particular when replacing the lens, it is essential that the most important parameters be called up and selected to enable correct processing of the workpiece. For example, the processing table position or processing table height is also changed by replacement of a lens, as the new lens will have a different focal length. This means that the essential parameters are automatically adjusted in the software so that the user does not have to make any adjustments.

Advantageous embodiments are such in which the camera is arranged in the lid of the laser plotter housing and can be triggered both in the closed and open position of the lid. This ensures that the camera used to capture the position of an inserted workpiece in the processing chamber can also be used to detect the lens and/or nozzle. Thus one camera is sufficient to determine the position of a workpiece in a processing chamber of a laser plotter and detect a lens and/or nozzle on a focusing unit of a laser plotter. However, it is of course also possible for a dedicated camera to be arranged for detecting the lens and/or nozzle, so that the focusing unit is adjusted to take an image depending on the position of this camera.

Advantageous embodiments are such in which the detected lens and/or nozzle is compared with the lens and/or nozzle selected in the control unit or a software, or in which the detected lens and/or nozzle is accepted by the control unit. This ensures that exchange of a lens and/or nozzle is detected automatically. If the lens and/or nozzle used does not match the selected lens and/or nozzle, the user is informed, for example by opening a window on the connected component, in particular a laptop, that the lens and/or nozzle used does not match the selected lens and/or nozzle. Preferably, furthermore a query is performed as to whether the newly used lens and/or nozzle should be accepted. If the lens and/or nozzle match, the machining process can be started, for example. It is possible for the lens and/or nozzle to be queried or checked automatically after the machining process has been activated.

However, advantageous embodiments are also such in which the camera takes several images of the focusing unit or the lens and/or nozzle at different positions of the focusing unit. This ensures that at least one image of good quality is generated among the large number of recorded images for evaluation by the analysis tool.

Advantageous embodiments are such in which a reference image of the focusing unit is recorded by the camera and stored in a database. This makes it possible to compare the captured image with the reference image quickly and easily.

Advantageous embodiments are such in which the position of the lens and/or nozzle is defined on the reference image, and a newly recorded image evaluated at this position. This enables rapid evaluation, as the areas to be evaluated are stored in the reference image.

Advantageous embodiments are such in which the lens and/or nozzle is compared with the lens and/or nozzle stored in the software after detection. This ensures that deviations are detected automatically.

Advantageous embodiments are such in which the detection of the lens and/or nozzle is carried out at the start of a job. This ensures that the lenses and/or nozzle used are checked when a job is called up without an external component connected.

Embodiments in which the detected lens and/or nozzle are stored on a storage medium, in particular in a cloud, are advantageous. This ensures that easy access for remote maintenance is possible. Furthermore it can be used to collect data that can be used for warranty processing.

However, advantageous embodiments are also such in which for processing the workpiece a laser beam emitted by the irradiation source is sent via preferably deflecting elements to at least one focusing unit, from which the laser beam is deflected in the direction of the workpiece and focused for processing, wherein the control is performed via software running in a control unit, preferably by processing a so-called job, in particular of transferred or loaded data, wherein the workpiece is processed by adjusting a carriage preferably via a belt drive in X-Y direction, wherein a graphic and/or a text is generated preferably on an external component, in particular a computer or a control unit, using a commercially available or proprietary software, such as CorelDraw, Paint, Ruby®, etc., which is transferred or exported to the control unit of the laser plotter, which converts the transferred data, in particular the graphic and/or the text, to control the individual elements of the laser device or laser plotter. This ensures that the workpiece can be processed after detection of the lens and/or nozzle. Here it is possible for the lens and/or nozzle to be queried automatically at the start of a machining process, or for the lens and/or nozzle to be queried manually first and then the machining process to be started.

Advantageous embodiments are such in which an image of a code or lettering is captured by the camera in an approximately vertical direction, wherein the lens or lens holder and/or nozzle or nozzle holder is formed according to any one of claims 17 to 22. This means that the special design of the lens or lens holder and/or the nozzle or nozzle holder allows the code or marking to be applied to the top of the housing extension parallel to the processing table, so that the camera can record the code or marking directly, i.e. almost vertically. This enables easy analysis in the analysis tool.

Embodiments in which the lens or lens holder and/or nozzle or nozzle holder is provided with a code in the form of a QR code (33) or Data Matrix code, in particular Data Matrix code ECC200, are advantageous. This enables easy detection via a camera. To this end, software known from the prior art, in particular for the analysis tool, can be used to evaluate and detect a QR code.

Advantageous embodiments are such in which further information, such as the deviation from the ideal focus value or differing wavelengths for different focus points or focal lengths, etc., is stored in the code, in particular QR code or Data Matrix code ECC200. This ensures that the laser device or laser plotter can be adjusted precisely by evaluating the code. In addition to the lens type, other important information, which can be different for each lens of the same type, is captured individually, i.e. that two lenses of type 2.5″, for example, have different deviations from the ideal focus value for 2.5″, which can be communicated to the laser device or the external component via the code. This enables precise adjustment, especially of the focus point or focal length.

Furthermore, the objective of the present disclosure is achieved by a laser plotter for engraving, marking and/or labeling a workpiece, in which, in order to record an image of the focusing unit and/or a partial area of the focusing unit, the latter is moved or positioned into a defined position, whereby an analysis tool is formed for evaluating the lens and/or nozzle.

The advantage here is that the lens and/or nozzle used or inserted is automatically identified. Preferably, after detection of the lens and/or nozzle the same is compared with the lens and/or nozzle stored in the software, and a message is displayed if there is a deviation. It is also possible for the queried lens and/or nozzle to be automatically accepted into the software.

In an advantageous embodiment the analysis tool is designed to evaluate optical features, in particular the color of the lens and/or nozzle housing, an imprint on the lens and/or nozzle housing, the geometric shape or surface structure of the lens and/or nozzle housing. This ensures that the lenses and/or nozzles used can be evaluated by simply taking an image of the focusing unit.

However, the objective of the disclosed embodiments is also achieved by a lens holder in which the lens housing has a housing extension on which a code for the approximately vertical image recording of a camera is arranged.

Furthermore, the objective of the disclosed embodiments is also achieved by a nozzle holder in which the nozzle housing has a housing extension on which a code for the approximately vertical image recording of a camera is arranged.

The advantage of the housing extension is that on the one hand it provides sufficient space for a code, and on the other hand it can also be used as a handle when replacing the lens, as the housing extension deviates from the housing contour of the laser head or focusing unit and protrudes. This prevents the user from touching the inserted lens with his or her fingers, for example, which can cause health risks and can also scratch or destroy the lens.

The design in which the housing extension has a recess or a raised edge area for better retention when replacing lenses is also advantageous. This ensures that the user achieves a good grip with his or her fingertips.

A design in which the code is in the form of a QR code or Data Matrix code, in particular Data Matrix code ECC200, is advantageous. This ensures that more information about the lens used can be stored and read via the QR code or Data Matrix code, in particular Data Matrix code ECC200. Furthermore, the QR code or Data Matrix code, in particular the ECC200 Data Matrix code, can be read more easily by taking an image from above, which is approximately vertical. The housing extension makes it possible for the first time to attach a QR code or Data Matrix code, in particular Data Matrix code ECC200, for automatic detection and scanning of the lens and/or nozzle.

In an advantageous embodiment, the QR code or Data Matrix code, in particular Data Matrix code ECC200, is applied within the raised edge area or the recess. This ensures that the attached code is protected against scratching.

In an advantageous embodiment, the code, in particular QR code or Data Matrix code ECC200, contains further information such as the deviation from the ideal focus value or differing wavelengths for different focus points or focal lengths, etc., This enables precise adjustment of the laser device or laser plotter for a machining process.

Advantageous embodiments are such in which the lens holder and/or the nozzle holder is designed for use or application in the method according to any one of claims 1 to 13 and/or for use in a laser plotter according to any one of claim 14 or 15. This enables easy image capture of the code arranged on the top side, which is captured directly or almost vertically by the camera.

Furthermore, the objective of the present disclosure is achieved by a laser plotter for engraving, marking and/or labeling a workpiece, in which the focusing unit or the laser head is positioned for lens detection and/or nozzle detection in such a way that a camera, which is preferably positioned centrally in the lid, creates or records an approximately perpendicular image of the code from the lens holder and/or nozzle holder, in particular the housing extension.

Here it is advantageous that the code applied to the top of the housing extension can be securely accommodated, as the housing extension is not covered by any elements or components of the laser machine.

The invention is now described in the form of an exemplary embodiment, whereby it is emphasized that the invention is not limited to the exemplary embodiment or solution shown and described, but can be applied to equivalent solutions.

### BRIEF DESCRIPTION OF THE DRAWINGS

FIG. 1 is a schematic illustration of a laser device, in particular a laser plotter, for processing a workpiece with a camera system on the lid-simplified, for illustrative purposes only;

FIG. 2 is a schematic illustration of a laser device, in particular a laser plotter, according to FIG. 1, with a correspondingly positioned focusing unit for detecting the lens and/or nozzle-simplified, for illustrative purposes only;

FIG. 3 is a schematic illustration of an exemplary embodiment of a lens holder or lens mount with a housing extension-simplified, for illustrative purposes only;

FIG. 4 is a further embodiment of a lens holder or lens mount with a housing extension-simplified, for illustrative purposes only;

FIG. 5 is a schematic illustration of an exemplary embodiment of a lens holder or lens mount with a housing extension and raised edge area-simplified, for illustrative purposes only;

FIG. 6 is a further exemplary embodiment of a lens holder or lens mount with a housing extension and raised edge area with a guide element arranged at the top-simplified, for illustrative purposes only;

FIG. 7 is a schematic representation of a laser machine with a lens mount inserted with a housing extension-simplified, for illustrative purposes only;

FIG. 8 is an approximately vertical image of the camera with the lid open, with a lens mount and nozzle mount with housing extension-simplified, for illustrative purposes only;

FIG. 9 is another approximately vertical image of the camera with open lid with a lens mount and nozzle mount with housing extension-simplified, for illustrative purposes only;

FIG. 10 is an approximately vertical image of the camera with the lid closed, with a lens mount and nozzle mount with housing extension-simplified, for illustrative purposes only;

FIG. 11 is an enlarged image section according to FIG. 10—simplified, for illustrative purposes only.

By way of introduction, it should be noted that in the various embodiments, identical parts are provided with identical reference signs or identical component designations, respectively, and the disclosures contained in the entire description can be applied mutatis mutandis to identical parts with identical reference signs or identical component designations, respectively. The positional information selected in the description, such as top, bottom, side, etc., likewise refers to the figure described and is to be transferred to the new position mutatis mutandis in the event of a change of position.

### DETAILED DESCRIPTION OF EMBODIMENTS

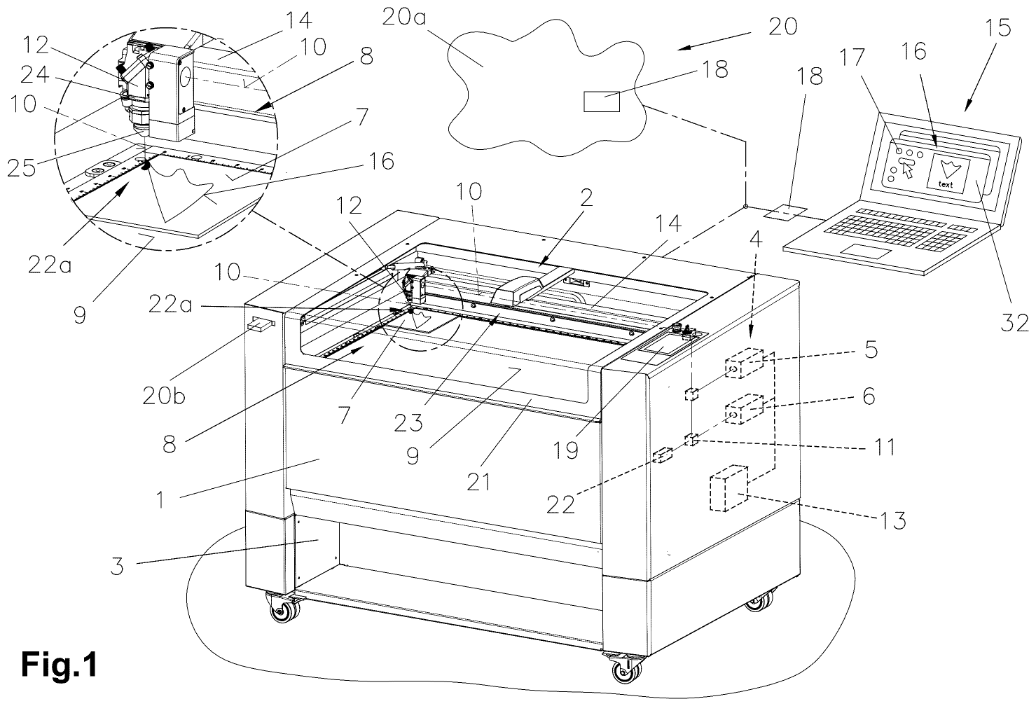

FIGS. 1 to 11 show an exemplary embodiment of a laser device 1, in particular a laser plotter 1, into which a camera system 2 is integrated.

In the laser plotter 1 shown, at least one, preferably two, irradiation sources 4 or laser sources 4 in the form of lasers 5, 6 are arranged in a housing 3. The lasers 5 and 6 preferably act in alternating fashion on a workpiece 7 to be processed. The workpiece 7 is positioned in a processing chamber 8 of the laser plotter 1, in particular on a processing table 9, whereby the processing table 9 is preferably height-adjustable. A laser beam 10 emitted by an irradiation source 4, in particular the laser 5 or 6, is sent via deflection elements 11 to at least one movable focusing unit 12 or laser head 12, from which the laser beam 10 is deflected in the direction of the workpiece 7 and focused for processing. The control, in particular the position control of the laser beam 10 in relation to the workpiece 7, is carried out via software running in a control unit 13, whereby the workpiece 7 is processed by adjusting a carriage 14, on which the focusing unit 12 or laser head 12 is also movably arranged, via preferably a belt drive in the X-Y direction. Here it is possible, for example, that in the “engraving” machining process, the carriage 14 is moved line by line, whereas in the “cutting” machining process, the carriage 14 is moved according to the contour to be cut, i.e. not line by line.

On an external component 15, in particular a computer, laptop or a control unit, a graphic 16 and/or a text 16 is created or loaded, respectively, using a commercially available software 17, such as CorelDraw, Paint, etc., or a proprietary application software 17, in particular Ruby® 17, which is exported or transferred, respectively, to the control unit 13 of the laser device or laser plotter 1 in the form of a job 18. Preferably, the data to be transferred are converted by the same or a different software so that the control unit 13 can process the job 18. Of course, it is also possible for the input to be made directly on the laser plotter 1 using the available input means 19, such as a touchscreen 19 or input buttons, or for a corresponding job 18 to be loaded from a storage medium 20, such as a cloud 20a, a USB stick 20b, etc. After the data, in particular the job or jobs 18, have been transferred or created directly or loaded from the storage medium 20, the laser device or laser plotter 1, in particular its control unit 13, processes the job 18. Here it is possible for several jobs 18 to be stored simultaneously in the laser device 1, in particular the laser plotter 1, and processed sequentially.

With laser devices 1, in particular laser plotters 1, of this type, for safety reasons it is necessary that a lid 21 or door 21, which is preferably at least partially transparent, be closed to start a job 18 to be processed in which the laser beam 10 acts on the workpiece 7, as shown in FIG. 1. The operating staff can then manually or alternatively automatically position the laser dot or a laser pointer 22, in particular laser pointer dot 22a, which is coupled into the beam path of the laser 5, 6 and is deflected in the direction of the processing table 8 via the focusing unit 12, on the inserted workpiece 7, whereupon the job 18 for processing the workpiece 7 can be started. At the end of the job 18, the carriage 14 and the focusing unit 12 or laser head 12 are then preferably moved to the starting position so that the finished workpiece 7 can be removed, whereupon a new machining process can be started by inserting a new workpiece 7 or blank 7, respectively, to be machined. It is advantageous to have the end of processing indicated visually or acoustically so that the user does not need to constantly monitor the laser device 1, in particular the laser plotter 1. For the sake of completeness, it is mentioned that the focusing unit 12 or laser head 12 can also be adjusted with the laser pointer 22 activated when the lid 17 is open, but the laser 5, 6 cannot be activated.

Furthermore, at least one camera 23 is provided in the camera system 2, whereby the camera 23 is located in the lid 21, in particular centrally in the middle of the lid 21. The camera 23 is designed to record the processing chamber 8, in particular the processing table 9, so that an inserted workpiece 7 can be detected. To ensure that one camera 23 is sufficient for a larger processing chamber 8, the camera 23 used preferably has a fisheye lens, whereby a calibration must be carried out to de-skew the recorded processing chamber 8 when the camera 23 is used for the first time. However, it is also possible for two or more cameras 23 to be arranged in the lid 21 in order to be able to capture the entire processing table 9, whereby preferably fisheye optics or normal optics can be used for this purpose. For example, the position of the inserted workpiece 7 is captured by the camera 23 and preferably displayed on the external component 15, in particular the laptop. The position of the workpiece 7 is preferably captured before machining or the start of the machining process, so that the focusing unit 12 or the laser head 12 can be positioned accordingly via the laser pointer 22. For the sake of completeness, it should be noted that the position of the workpiece 7 can also be detected when the lid 21 is open.

For the novel laser plotter 1 or laser machine 1, it is now envisioned that the laser machine 1 or laser plotter 1 performs a method for detecting a lens 24 and/or nozzle 25 on the focusing unit 12 of the laser plotter 1 for cutting, engraving, marking and/or labeling the workpiece 7, or the laser plotter 1 is designed for this purpose.

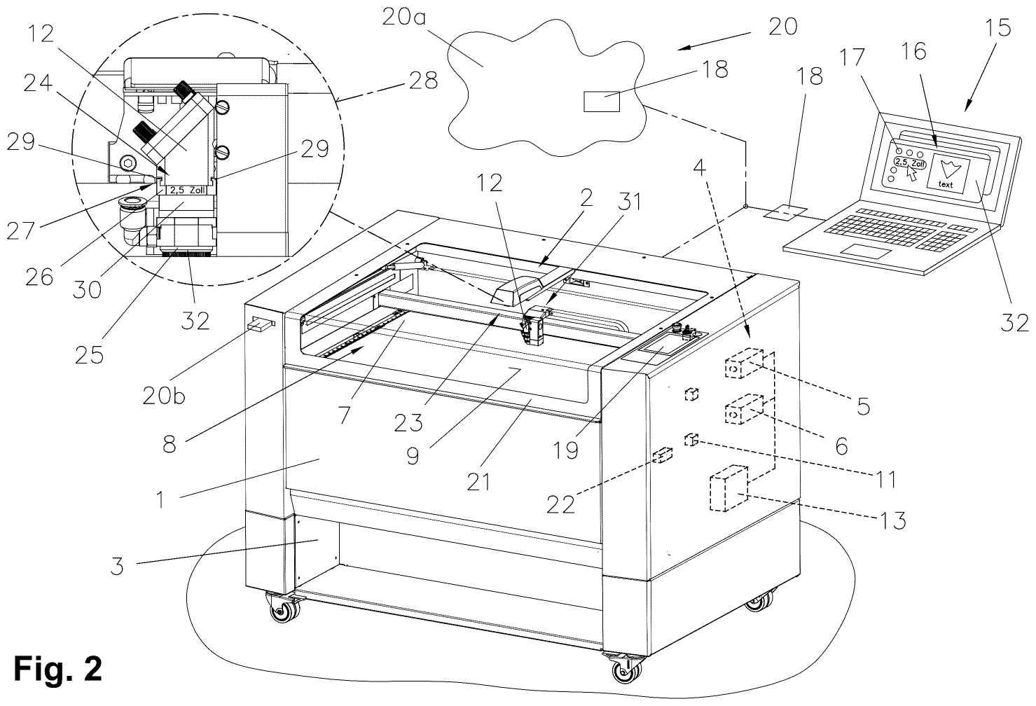

The focusing unit 12 or the laser head 12 is designed in such a way that a lens housing 26 of the lens 24 can be inserted into or removed from a lens mount 27 from the outside, as can be seen on an image 28 of the focusing unit 12 taken by the camera 23 in FIG. 2. Preferably, guides 29 are provided on the sides of the lens housing 26 for this purpose in order to be able to insert the lens 24 correctly into the focusing unit 12. However, in order for a lens 24 to be replaced, a fastening wheel 30 must first be loosened so that the lens 24 can then be removed. To this end, the fastening wheel 30 is preferably rotated downwards so that the fastening wheel 30 releases the clamping of the lens 24 and the lens 24, in particular the lens housing 26, can be pulled out from the lens mount 27. In order to subsequently reinsert a lens 24, the lens 24 is first inserted or pushed into the lens mount 27 and then fixed or clamped by turning the fastening wheel 30, preferably upwards, so that the lens 24 is securely fastened to the focusing unit 12. The lens housing 26 is designed in such a way that it has optical or color features on at least one side, such as the color of the lens housing 26 or an imprint on the lens housing 26 or a lettering or engraving on the lens housing 26 or a specific geometric shape or surface structure of the lens housing 26, in order to enable unambiguous identification of the lens 24 used.

The nozzle 25 can likewise be removed from the focusing unit 12 and thus be replaced. This is done simply by rotating the nozzle 25. Here, too, it is envisioned that the nozzles 25 are marked with optical or color features, such as the color of the nozzle housing 32 or an imprint on the nozzle housing 32 or a lettering or engraving on the nozzle housing 32 or a specific geometric shape or surface structure of the nozzle housing 32.

However, in order to achieve a high level of user-friendliness, the laser plotter 1 according to the present disclosure provides for automatic detection of the lens 24 and/or nozzle 25 currently inserted or present.

To this end, after activation of the detection of the lenses 24 and/or nozzles 25 or automatically before the start of a machining process, a so-called detection process is started, for which purpose the irradiation source 4 is deactivated and the focusing unit 12 or the laser head 12 is moved to a specific position 31, which is as close as possible to the camera 23, as shown in FIG. 2. The position 31 is stored or saved in the internal software of the control unit 13 and/or external software 17 of the component 15, so that after each call the same position 31 is moved to. An image 28 of the focusing unit 12 or laser head 12 is then taken with the camera 23, as shown schematically in FIG. 2. The recorded image 28 is then evaluated directly by the software in the laser plotter 1 or by the software 17 on the connected component, in particular on the laptop, i.e. the lens 24 and/or nozzle 25, in particular the positions of the lens 24 and/or nozzle 25, are detected by the software or an analysis tool of the software, whereupon the optical or color features which are attached to the lens 24 and/or nozzle 25 or according to which the lens 24 and/or nozzle 25 is designed are evaluated. The analysis tool is integrated in the software of the laser control or conversion or creation of the job 18 and has the task of evaluating the captured image 28, or the analysis tool is integrated in the connected external component 15, in particular laptop, and the captured image 28 is sent to the external component 15, in particular laptop, for analysis. Here it is possible that the value of the lens 24, for example 2.0 inches, is captured and displayed directly on the lens housing 26, or that the lens housing 26 has a specific color so that the value stored for this color is then displayed.

Preferably, the detected lens 24 and/or nozzle 25 is compared with the lens 24 and/or nozzle 25 selected in the control unit 13 or the software 17. Here, a message or warning is output if the detected lens 24 and/or nozzle 25 differs from the selected lens 24 and/or nozzle 25, whereby it is preferably queried whether the newly detected lens 24 and/or nozzle 25 should be accepted or not. If “Do not accept” is selected here, a check is preferably carried out again before the start of the next machining process in order to determine whether the correct lens 24 and/or nozzle 25 has been inserted. It is noted as an advantageous solution that the lens 24 and/or nozzle 25 is checked after the start of the machining process and before the irradiation source 4 is activated. However, it is also possible that the detected lens 24 and/or nozzle 25 is simply always accepted by the control unit 13 or software 17.

By automatically detecting the lens 24 and/or nozzle 25, it is possible that further parameters can be loaded automatically, i.e. that criteria or default values are stored in a database for the lenses 24 and/or nozzles 25. For example, when changing the lens 24 from 2.0 inches to a lens 24 of 3.0 inches, the focal length is altered, so that a new machining table height is required, which is loaded from a stored database so that a new machining table height is used when the machining process is started. It is therefore advantageous to have the lens 24 and/or nozzle 25 detected first when a machining process is started, in order to compare the individual parameters with the lens 24 and/or nozzle 25 used and to be able to change them if necessary or to interrupt the machining process.

In principle, the lens 24 and/or nozzle 25 can be detected manually, in particular when the laser plotter 1 is commissioned, so that several machining processes can then be carried out. It is advantageous here if an exchange of the lens 24 and/or nozzle 25, i.e. the position in the focusing unit 12 or laser head 12, is monitored electrically or electronically, so that when an exchange is activated before the next machining process, the lens 24 and/or nozzle 25 is automatically detected if detection has not previously been started manually. Similarly, the detection process can take place or be started during the processing of the job 18, whereby it can be checked, depending on the specific engraving, marking or cutting job 18, whether the correct or suitable lens 24 and/or nozzle 25 is used, in particular with regard to the material to be processed or the focus distance, etc.

Preferably, the settings and criteria under which a job 18 is processed are stored, in particular in an external component 15 and/or cloud 20a, whereby error sources or flaws can be detected and/or subsequently analyzed. For example, remote maintenance can thus also be used to check whether original lenses 24 and/or nozzles 25 are being used. This is particularly important for fault analysis and can also provide essential information for the processing of guarantee and warranty claims.

Advantageous embodiments are such in which a reference image of the focusing unit 12 is recorded by the camera 23 and stored in a database. The database is preferably stored on the component 15 and/or another external storage medium 20, in particular the cloud 20a, and is preferably also designed or set up for remote access, e.g. by a remote maintenance team. However, the database can also be stored or arranged internally in the software 17 of the control unit 13. Here the position of the lens 24 and/or nozzle 25 is defined on the reference image and a newly recorded image 28 is evaluated at this position. This speeds up the detection process considerably.

It is also possible for the camera 23 to take several images 28 of the focusing unit 12 or the lens 24 and/or nozzle 25 at the same or different positions of the focusing unit 12 or laser head 12. This ensures that at least one evaluable image 28 has been recorded in order to be able to detect the lens 24 and nozzle 25. It is also possible to adjust the table height to accommodate one or more images 28.

Furthermore, it is also possible to move the focusing unit 12 or laser head 12 to a specific position in order to change the lens 24 and/or nozzle 25. To do this, a menu or button is activated in the software, or a button is activated on the laser plotter 1 so that the focusing unit 12 or laser head 12 is then moved to the interchange position.

An essential feature of the solution according to the present disclosure is that for detection of the lens 24 and/or nozzle 25, the focusing unit 12 is moved to a defined position 31 at which the lens 24 and/or nozzle 25 is clearly visible to the camera 23, whereupon at least one image 28 of the focusing unit 12 is recorded via the camera 23 and the lens 24 and/or nozzle 25 is detected in the image 28 via an analysis tool.

Preferably, the focusing unit 12 is moved into the close range of the camera 23, in particular at a short distance from the camera 23, in order to produce a clearly visible image 28, and preferably the processing table 9 is also set to a specific height. Here, the focusing unit 12 or laser head 12 is positioned at a small distance from the camera 23, at which the angle of view of the camera 23 enables the focusing unit 12 or laser head 12 or parts thereof, in particular the lens 24 and/or nozzle 25, to be photographed with good quality, so that the lens 24 and/or nozzle 25 used can be evaluated by the software, in particular the integrated analysis tool.

In the exemplary embodiment shown in FIGS. 1 and 2, a so-called approximately horizontal image of the lens 24 and/or nozzle 25 is taken by the camera 23. “Approximately horizontal” because a code or labeling 33 or identification of the lens and/or nozzle 24, 25 are attached to the side of the lens housing 26 or nozzle housing 32 and are thus formed at approximately 90° to the processing table 9 or 90° to the camera 23, so that an approximately horizontal alignment is created when the image 28 is captured.

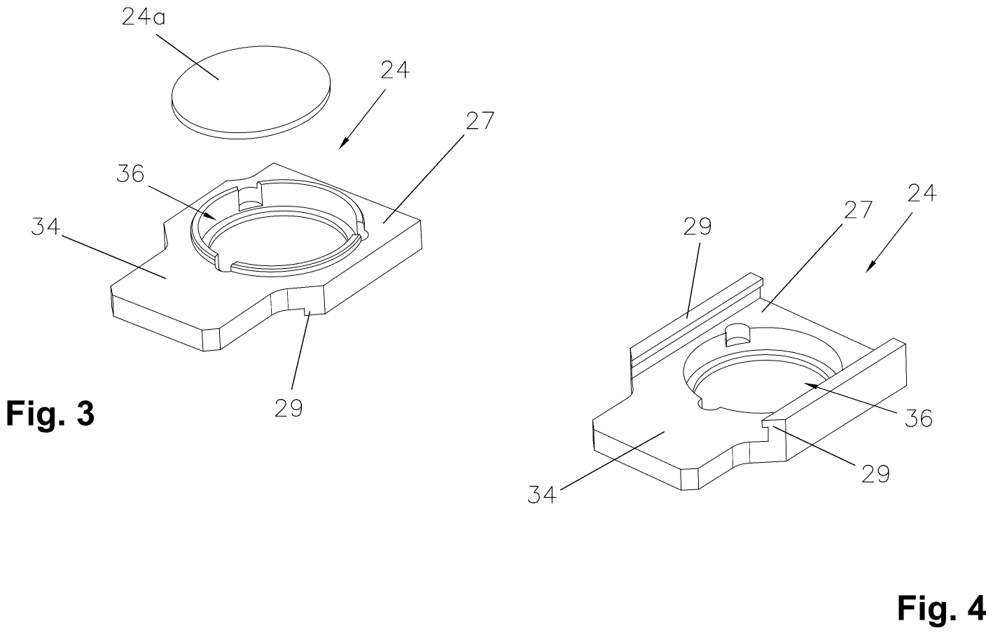

FIGS. 3 to 11 now show embodiments or exemplary embodiments in which an approximately vertical image recording of a code 33 or lettering 33 of the lens 24 and/or nozzle 25 is made possible, i.e. that the code 33 or the lettering 33 is no longer arranged or applied laterally on the lens housing 26 or nozzle housing 32, but the lens housing 26 has a housing extension 34 and/or the nozzle housing 32 has a housing extension 35 to which the code 33 or the lettering 33 is applied. The code 33 or the lettering 33 is now applied not laterally to the lens 24 or nozzle 25, but to a surface or upper side of the housing extensions 34, 35. The code 33 or the lettering is thus aligned parallel to the processing table 9, so that an approximately vertical image acquisition from the camera 23 is possible with the lid 21 open or closed.

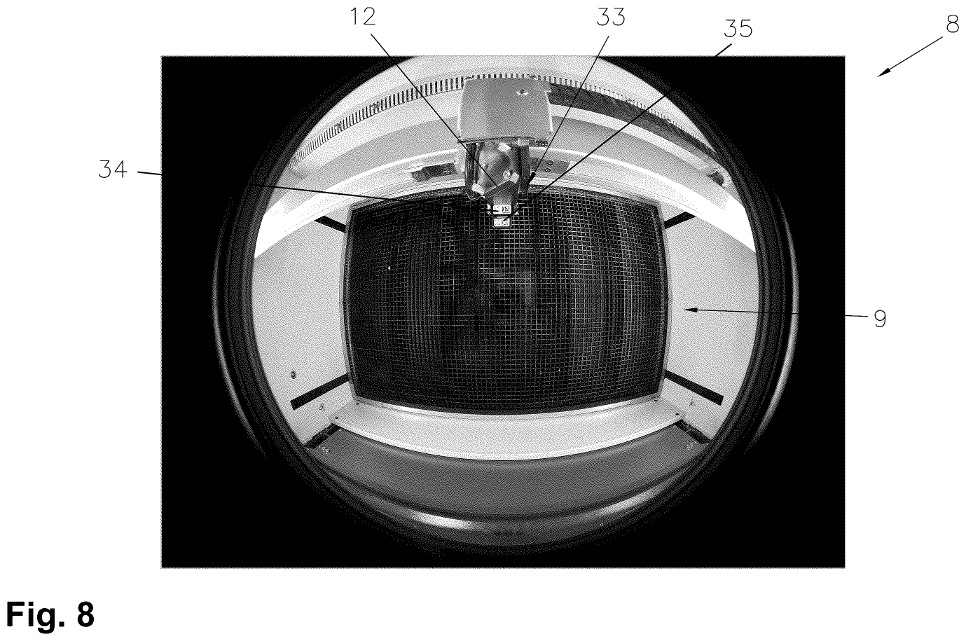

FIG. 3 shows a lens holder or a lens 24 with a lens housing 27 and the housing extension 34. The lens housing 27 has guides 29 or guide projections 29 on the underside. Furthermore, an optical lens 24a is shown which, in the assembled state, is fixed, in particular glued, into a receptacle 36 of the lens housing 27. By enlarging the lens housing 17 with the housing extension 34, which protrudes from the laser head 12, it is now possible to apply a code 33, in particular QR code 33 or Data Matrix code ECC200, and/or lettering 33, as shown in FIGS. 8 to 11, to the surface of the housing extension 34, since considerably more space is available. FIG. 4 shows a similarly constructed lens 24, in which the guides 29 are now arranged on the upper side of the lens housing 27. For the sake of clarity, the lens 24a is not shown.

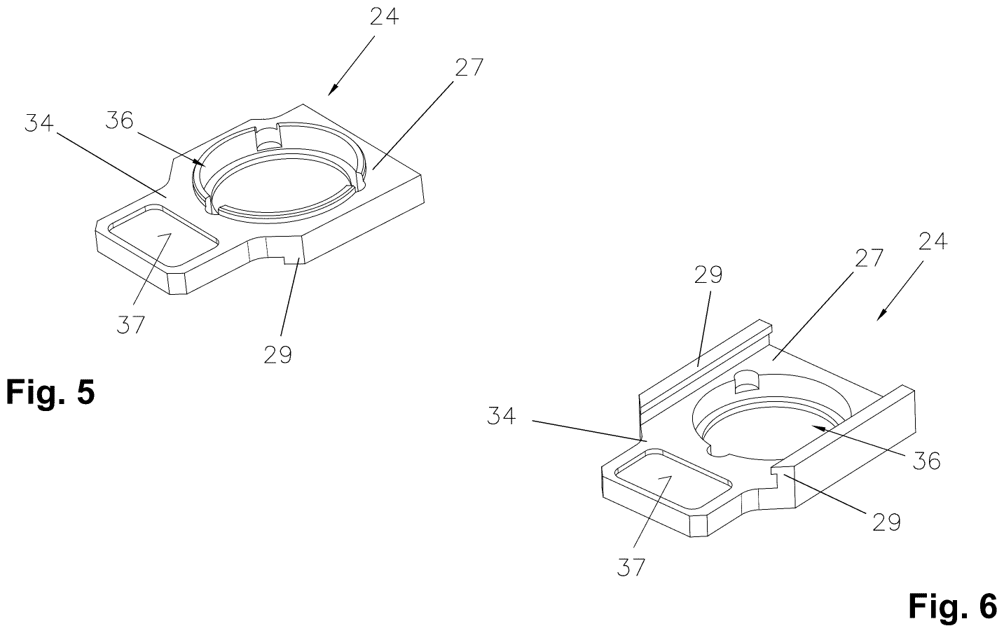

FIGS. 5 and 6 show similar exemplary embodiments of the lens holder or lens 24. The difference is that the housing extension 34 is specially designed. Here, the housing extension 34 has a recess 37 or a raised edge area for better retention during lens replacement. For the sake of clarity, the lens 24a is not shown in these FIGS. 5 and 6 either.

A special illustration of the housing extension 35 of the nozzle housing 32 of the nozzle holder or nozzle 25 has been omitted, whereby an embodiment example can be seen in FIGS. 8 to 11. Essentially, it should be mentioned here that the housing extension 35 for the nozzle 25 is now preferably designed as a further element which is attached to the nozzle 25 or accommodates the nozzle 25 in such a way that the applied code 33 or the lettering 33 is aligned or arranged in the same way as the applied code 33 of the lens 24 when the nozzle 25 is mounted on the laser head 12, i.e. parallel to the processing table 9, as can be seen in FIGS. 8 to 11.

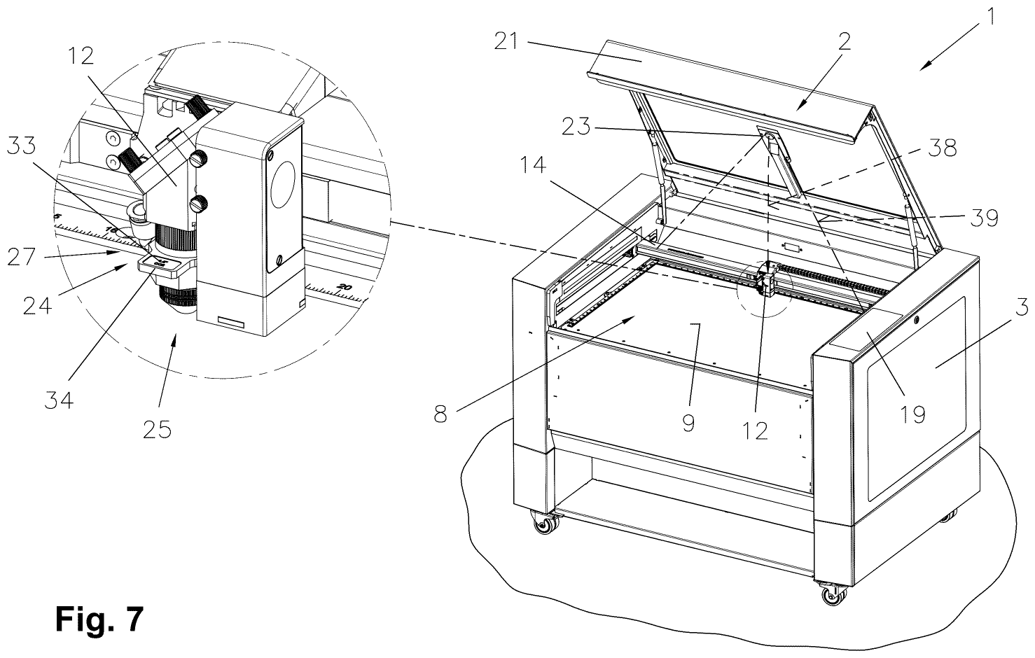

FIG. 7 shows an insert or application of a lens holder or lens 24 without a nozzle holder or nozzle 25. It can be seen that the housing extension 34 of the lens 24 is arranged outside the components or elements of the laser head 12 or the focusing unit 12 and thus protrudes. Thus, on the one hand, the lens 24 can be held securely by the housing extension 34 during replacement and, on the other hand, an unobstructed view of the top of the housing extension 34 from above, i.e. the position of the camera 23, is made possible. With the lid 21 closed or open, the camera 23 can thus take an approximately vertical image of the upper side of the protruding housing extension 34, as shown by arrow 38, so that the code 33 or lettering 33 applied to the upper side can be easily captured and evaluated by the analysis tool. It is advantageous here if the laser head 12 or the focusing unit 12 assumes a position 31 in which the recording area 39, as shown by the dotted line in FIG. 7, of the camera 23 can perform a slightly offset, approximately vertical image recording.

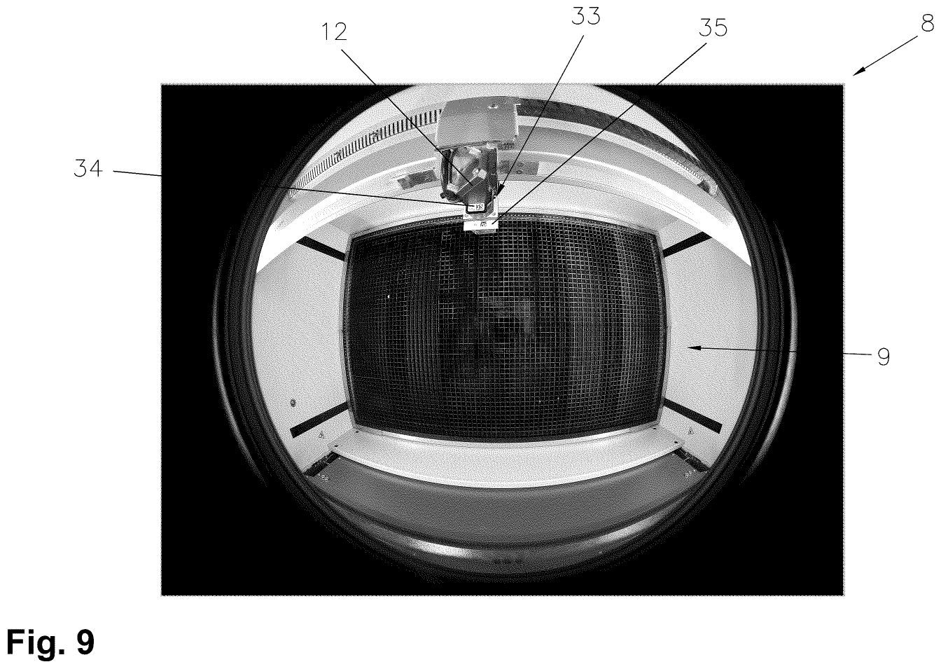

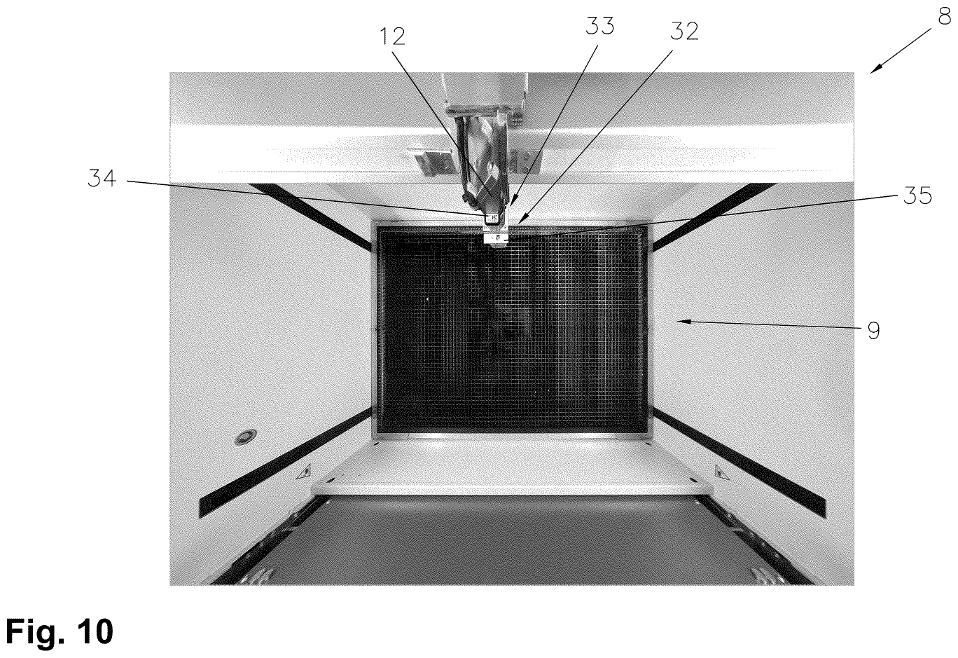

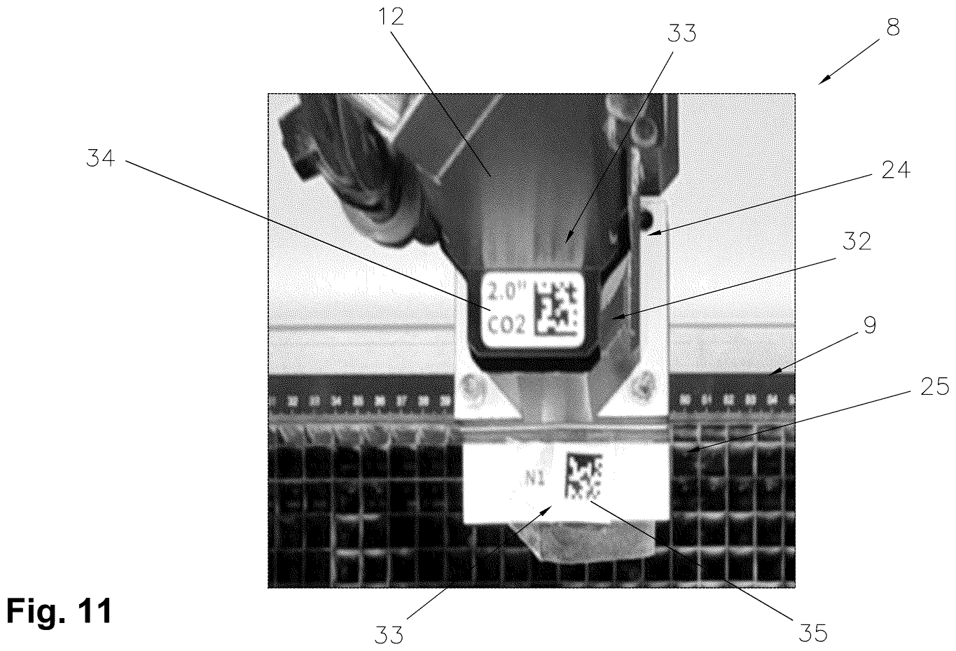

Furthermore, FIGS. 8 to 11 show images taken by the camera 23, whereby the images 28 of FIGS. 8 and 9 were taken with the lid 21 open and the image 28 of FIG. 10 was taken with the lid 21 closed. FIG. 11 shows an enlargement of the laser head 12 or the focusing unit 12 from FIG. 10, whereby the approximately vertical image of the code 33 or lettering 33 on the housing extensions 34, 35 of the lens 24 and nozzle 25 is clearly visible. In the images 28 of FIGS. 8 and 9, two different positions 31 of the laser head 12 or the focusing unit 12 are shown, so that it can be seen that different positions 31 for the detection of the lens 24 and/or nozzle 25 are also possible. It is advantageous to have the code 33 designed as a QR code 33 or Data Matrix code 33, in particular Data Matrix code ECC200, possibly with further information, as this can be used to store a large amount of data. For example, the deviation from the ideal focus value can also be stored in the code 33 of the lens 24, i.e. a 1.5″ lens 24 may actually not have a focus of 1.5″, for example, but a correction value reads 1.51″, so that the 0.01″ deviation is stored as a value or correction value in the Data Matrix code 33 and an optimum table setting can therefore be made for the focus point. This ensures that a customer buys an adjusted lens 24, whereby the exact settings for this lens 25 can be taken from the code 33 or label 33. Furthermore, it would also be possible for the additional information of the lens focus value for each wavelength to be stored in code 33, i.e. for differing lasers 5 or 6 there are also different focus points due to the different wavelengths, which can be queried via code 33 before the start of a machining process, for example. An automatic table height adjustment can also be carried out to set the optimum focus point. As a matter of principle, it can be said that correction values and/or information or data of the lens 24 and/or nozzle 25 can be stored in the code 33 and/or label 33 and queried.

The lens 24 and/or nozzle 25 is usually adjusted manually before each start of a machining process. Here, the user also performs a manual replacement of the lens 24 and/or nozzle 25, whereby the user adjusts the corresponding lens 24 and/or nozzle 25 before or afterwards or can have it adjusted automatically by a lens and/or nozzle detection system according to the present disclosure. Furthermore, it is possible that a lens and/or nozzle detection, which is started manually or automatically by activating it in the software, is carried out before each start of the machining process, in which the focusing unit 12 or the laser head 12 is positioned for lens detection and/or nozzle detection in such a way that an approximately vertical image 28 of the code 33 or labeling 33 is taken by the camera 23, which is positioned, preferably centrally, in the lid 21, creates or records an approximately vertical image 28 of the code 33 or lettering 33 of the lens holder or lens 24 and/or nozzle holder or nozzle 25, in particular the housing extension 34, 35 of the lens 24 and/or nozzle 25. Subsequently, the image 28 is transmitted to the analysis tool running on the control unit 13 of the laser machine 1 or on the external component, in particular on the laptop.

It is also possible that after a manual replacement of the lens 24 or nozzle 25, an automatic lens and/or nozzle detection is carried out, i.e. that an automatic detection of a lens replacement or nozzle replacement is present, so that a lens and/or nozzle detection is started at least before the next machining process or immediately after the replacement. The automatic detection of a change can be monitored by electrical, magnetic or optical detection systems. This makes it possible, for example, to detect whether a lens 24 has been removed and/or inserted, so that an automatic detection process can be started.

The definition “approximately vertical” was chosen because the laser head 12 or the focusing unit 12 cannot be positioned directly below the camera 23, i.e. vertically or directly, but a certain offset or angle is necessary in order to achieve optimum image capture of the code 33 or QR code 33 or Data Matrix code 33, in particular Data Matrix code ECC200, from the top of the housing extension 34,35 of the lens holder or lens 24 and/or nozzle holder or nozzle 25. Alternatively, it can also be said that a “top-shot” view is taken from the camera 23 onto the code 33 or the top of the housing extensions 34, 35 of the lens 24 and/or nozzle 25, which is slightly offset due to the laser head 12 or focusing unit 12.

For the record, it should be noted that the present disclosure is not limited to the embodiments shown, but may also include other designs and structures.

1. A method for detecting a lens or nozzle on a focusing unit of a laser plotter for cutting, engraving, marking and/or lettering a workpiece, in which at least one irradiation source in the form of a laser is used in a housing of the laser plotter, wherein, when the irradiation source is activated, a laser beam is directed via deflection elements to a focusing unit or laser head and a processing table or processing chamber is captured via at least one camera, wherein, in order to determine the lens or nozzle, the focusing unit or laser head is moved to a defined position at which the lens or nozzle is visible to the camera, whereupon an image of the focusing unit or laser head is recorded via the camera, and the lens or nozzle is detected in the image via an analysis tool.

2. The method according to claim 1, wherein the lens is identified by means of optical features, such as the color of a lens housing or an imprint on the lens housing or a lettering or engraving on the lens housing or the geometric shape or surface structure of the lens housing.

3. The method according to claim 1, wherein the nozzle is identified by means of optical features, such as the color of the nozzle housing or an imprint on the nozzle housing or a lettering or engraving on the nozzle housing or the geometric shape or surface structure of the nozzle housing.

4. The method according to claim 1, wherein criteria or default values for the lenses and/or nozzles are stored in a database.

5. The method according to claim 1, wherein the camera (23) is arranged in the lid (21) of the housing (3) of the laser plotter (1) and can be triggered both in the closed and in the open position of the lid (21).

6. The method according to claim 1, wherein in the detected lens (24) and/or nozzle (25) is compared with the lens (24) and/or nozzle (25) selected in the control unit (13) or a software (17), or in that the detected lens (24) and/or nozzle (25) is accepted by the control unit (13) or the software (17).

7. The method according to claim 1, wherein a plurality of images (28) of the focusing unit (12) or the lens (24) and/or nozzle (25) are recorded by the camera (23) at different positions of the focusing unit (12).

8. The method according to claim 1, wherein a reference image of the focusing unit (12) is recorded by the camera (23) and stored in a database.

9. The method according to claim 8, characterized in that the position of the lens (24) and/or nozzle (25) is defined on the reference image, and a newly recorded image (28) is evaluated at this position.

10. The method according to claim 1, wherein after detection of the lens (24) and/or nozzle (25) the same is compared with the lens (24) and/or nozzle (25) stored in the software.

11. The method according to claim 1, wherein the detection of the lens (24) and/or nozzle (25) is carried out at the start of a job (18).

12. The method according to claim 1, wherein the detected lens (24) and/or nozzle (25) are stored on a storage medium (20), in particular in a cloud (20a).

13. The method according to claim 1, wherein for processing the workpiece (7) a laser beam (10) emitted by the irradiation source (4) is sent via preferably deflecting elements (11) to at least one focusing unit (12), from which the laser beam (10) is deflected in the direction of the workpiece (7) and focused for processing, wherein the control is performed via software running in a control unit (13), preferably by processing a so-called job (18), in particular of transferred or loaded data, wherein the workpiece (7) is processed by adjusting a carriage (14) preferably via a belt drive in X-Y direction, wherein a graphic (16) and/or a text (16) is generated preferably on an external component (15), in particular a computer or a control unit, using a commercially available or proprietary software (17), such as CorelDraw, Paint, Ruby®, etc., which is transferred or exported to the control unit (13) of the laser plotter (1), which converts the transferred data, in particular the graphic (16) and/or the text (16), to control the individual elements of the laser device or laser plotter (1).

14. The method according to claim 1, wherein at an image recording of a code (33) or lettering (33) is made by the camera (23) in an approximately vertical direction, whereby the lens (24) or lens holder and/or nozzle (25) or nozzle holder are designed according to any one of claims 17 to 22.

15. The method according to claim 1, wherein the lens (24) or lens holder and/or nozzle (25) or nozzle holder is provided with a code (33) in the form of a QR code (33) or Data Matrix code, in particular Data Matrix code ECC200.

16. The method according to claim 1, wherein further information, such as the deviation from the ideal focus value or differing wavelengths for different focus points or focal lengths, etc., is stored in the code (33), in particular QR code (33) or Data Matrix code ECC200.

17. A laser plotter (1) for engraving, marking and/or lettering a workpiece (7), which comprises a processing chamber (8) for positioning the workpiece (7), at least one preferably, however, two irradiation sources (4) in the form of lasers (5, 6) with corresponding deflection elements (11) and a control unit (13) for controlling a carriage (14), which is operated via preferably a belt drive, with a focusing unit (12) arranged so as to be movable thereon, wherein a camera (23) is arranged to record an image of the processing chamber, whereto in order to record an image (28) of the focusing unit (12) and/or of a partial area of the focusing unit (12), the same is moved or positioned into a defined position (26), wherein an analysis tool is designed for evaluating the lens (24) and/or nozzle (25).

18. The laser plotter (1) according to claim 17, wherein the analysis tool is designed to evaluate optical features, in particular the color of the lens and/or nozzle housing (26, 32), an imprint on the lens and/or nozzle housing (26, 32), the geometric shape or surface structure of the lens and/or nozzle housing (26, 32).

19. A holder for automatically detecting a lens (24) on a laser head (12) or focusing unit (12) of a laser plotter (1), comprising at least one lens housing (26), into which a lens (24a) is fastened, in particular glued, whereby guides (29) for insertion into a laser head housing (12) or focusing unit (12) are preferably arranged on the lens housing (26), wherein the lens housing (26) has a housing extension (34) on which a code (33) for the approximately vertical image recording of a camera (23) is arranged.

20. The holder according to claim 1, wherein the holder is for automatically detecting a nozzle (25) on a laser head (12) or focusing unit (12) of a laser plotter (1), comprising at least one nozzle housing (32), wherein the nozzle housing (32) has a housing extension (35) on which a code (33) for the approximately vertical image recording of a camera (23) is arranged.

21. The older according to claim 19, wherein the housing extension (34, 35) has a recess (37) or a raised edge area for better retention during lens replacement or nozzle replacement.

22. The method according to claim 19, wherein the code (33) is provided in the form of a QR code (33) or Data Matrix code, in particular Data Matrix code ECC200.

23. The holder according to claim 22, wherein the QR code (33) or Data Matrix code, in particular Data Matrix code ECC200, is applied within the raised edge region or the recess (37).

24. The holder according to claim 19, wherein further information, such as the deviation from the ideal focus value or differing wavelengths for different focus points or focal lengths, etc., is stored in the code (33), in particular QR code (33) or Data Matrix code ECC200.

25. (canceled)

26. The laser plotter according to claim 17, wherein for lens detection and/or nozzle detection the focusing unit (12) or the laser head (12) is positioned in such a way that a camera (23) positioned, preferably centrally, in the lid (21), creates or records an approximately vertical image (28) of the code (33) from the lens holder and/or nozzle holder, in particular the housing extension (34, 35).

27. The laser plotter (1) according to claim 26, characterized in that the laser plotter (1) is designed for application or implementation of a method according to any one of claims 1 to 16 and/or for use in a laser plotter according to any one of claim 17 or 18, wherein preferably a lens holder and/or a nozzle holder according to any one of claims 19 to 25 can be used.
